(19) United States
(12) Patent Application Publication
(10) Pub. No.: US 2020/0027108 A1
(43) Pub. Date: Jan. 23, 2020

(54) SYSTEM AND METHOD FOR REFERRAL OPTIMIZATION AND COMPENSATION

(71) Applicant: My-Nyoobe, Inc., Blackshear, GA (US)

(72) Inventors: Derek Tippins, Blackshear, GA (US); Michael Lee, Blackshear, GA (US)

(21) Appl. No.: 16/042,689

(22) Filed: Jul. 23, 2018

(51) Int. Cl. G06Q 30/02; G06F 17/30

(52) U.S. Cl. CPC G06Q 30/0214; G06F 17/30864

(57) ABSTRACT

A method of processing a referral transaction in a referral system having business and user members. The method comprises receiving, at a processor of a first user device, input from a first user for initiating a referral transaction, capturing, using a camera coupled to the processor, an image relating to the referred business, generating a unique referral code associated with member information of the user and the business, and communicating over a network to post a link that includes the referral code. Activation of the link by a second user provides the second user a referral that can be redeemed at the member business, and the first user and the second user receive compensation from the referral system upon confirmation of the redemption of the referral.

### FIELD OF THE INVENTION

The inventions described herein generally relate to network-based advertising and referral systems. In particular, embodiments relate to systems, methods and computer program products for referral optimization and compensation.

### BACKGROUND OF THE INVENTION

Businesses often rely on advertising to attract new customers. While market research and other types of analysis are used to target advertisements toward customers deemed most suitable, some proportion of the total costs spent by businesses on advertising is inevitably not optimally targeted. Businesses therefore do not know ahead of time which advertisements will “stick” and attract new customers. For example, advertisers and market specialists may advise businesses as to the optimal medium (e.g., radio, internet, magazine), entity (e.g., particular radio station or website), duration, and style for a target audience, but all such recommendations are subject to uncertainties, particularly as the number of advertising sites and forums proliferates with the internet and social networks. This uncertainty makes it difficult for business to either set an advertising budget with a sufficient degree of assurance that it is the right amount, or to allocate a budget after it is set with a sufficient degree of assurance that the budget is being well spent.

In addition, even when advertising works successfully, it is sometimes challenging for businesses to track new customers and correlate specific advertisements with new business. Tracking can be particularly challenging for brick-and-mortar businesses that transact a large amount of business at the point of sale in an offline mode.

It would therefore be advantageous to provide a way for businesses to obtain new customers without up-front advertising costs, and to track the new customers automatically.

### SUMMARY OF THE INVENTION

Embodiments of the present invention provide a computer and mobile device-implemented method of processing a referral transaction in a referral system having business and user members. The method comprises receiving, at a processor of a first user device, input from a first user for initiating a referral transaction, capturing, using a camera coupled to the processor, an image related to the referred business, generating a unique referral code associated with member information of the user and the business, communicating over a network using any electronic sharing method, including social media sites and posting a link including the referral code via the electronic sharing method. Activation of the link by a second user provides the second user a referral that can be redeemed at the member business, and the first user and the second user receive compensation from the referral system upon confirmation that the second user redeemed the referral.

In some embodiments, the method further comprises receiving user input including information identifying a business, sending a communication to a referral platform of the referral system including the information identifying the business, and receiving back information as to whether the business is a member of the referral system from the referral system platform. The first user, second user and business can each receive member identification numbers from the referral platform upon becoming members of the referral system. In certain implementations, the referral code includes a portion of a member identification number of the first user and a portion of the member identification number of the business established.

Additional embodiments of the present invention also provide a computer-implemented or mobile device implemented method of processing a referral transaction in a referral system having business and user members that comprises receiving, at a processor of a user device, input from a user to activate a link to a referral associated with a business posted on a social network site of which the user is a member, storing metadata related to the referral, receiving input to activate a referral transaction based on the referral, capturing, using a camera coupled to the processor, an image of a receipt recording a purchase made at the business associated with the referral, and communicating over a network with a referral platform to confirm that a valid purchase has been made using the referral.

In some embodiments, the method further comprises blocking the user device from obtaining additional referrals associated with the business for a set time determined by the business. In some implementations, upon receiving input to a user to activate the link, it is determined whether the user device includes an application adapted for processing transactions in the referral system. An automatic download of the application adapted for processing transactions in the referral system can be initiated if it is determined that the user device does not include the application.

In addition, the present invention provides a method for the registration of business in a referral system. In some implementations, the method includes determining, at a first user device, if a business is a member of the referral system, presenting a video to an owner of the business if it is determined that the business is not a member of the referral system, and sending a link to the business to register as a member of the referral system. The first user is then affiliated with the business upon registration of the business with the referral system, and the first user receives compensation for all referral transactions conducted by the business.

These and other features can be appreciated from the accompanying description of certain embodiments of the invention which are discussed in relation to the accompanying drawing figures. The drawing figures are illustrative and not necessarily to scale.

### BRIEF DESCRIPTION OF THE DRAWINGS

FIG. 1 is a schematic diagram illustrating a referral optimization and compensation system according to an embodiment of the present invention.

FIG. 2 is an example search screen provided by the referral application according to an embodiment of the present invention.

FIG. 3 is a flow chart of process of registering a business and an affiliate with the referral system according to an embodiment of the present invention.

FIG. 4 is a flow chart of a first part of a referral transaction process according to an embodiment of the present invention

FIG. 5 is a flow chart of a second part of a referral transaction according to an embodiment of the present invention

FIG. 6 is a block diagram depicting an example compensation arrangement of the referral system according to an embodiment of the present invention.

FIG. 7 is an example user interface screen presented by the referral app according to an embodiment of the present invention.

FIGS. 8A-8F are other examples of user interface screens presented by the referral app according to an embodiment of the present invention.

FIGS. 9A-9B are other examples of user interface screens presented by the referral app according to an embodiment of the present invention.

FIG. 9C shows a receipt being captured by a camera activated by the referral app according to an embodiment of the present invention.

FIG. 10 is an example interface screen provided by the referral platform according to an embodiment of the present invention.

FIG. 11 is another example interface screen provided by the referral platform according to an embodiment of the present invention.

FIG. 12 is another example interface screen provided by the referral platform according to an embodiment of the present invention.

FIG. 13 is another example interface screen provided by the referral platform according to an embodiment of the present invention.

### DETAILED DESCRIPTION CERTAIN OF EMBODIMENTS OF THE INVENTION

The embodiments of the present invention provide a downloaded front-end mobile application (referred to herein after as the “referral app”) that enables individuals to become members of a network-based referral system and to register businesses with a referral platform. Once a business has been registered with the referral platform, it is affiliated with the user that initiated the registration, who is referred to as the “affiliate” of the business. A business may register on its own without having an affiliate. Additional members of the referral system that have downloaded the referral app can then locate member businesses using an in-built search function of the referral app, purchase goods or services at member businesses, and generate referrals to the business. For example, a member, “User 1”, can make a purchase at a member business, “Business 1”, capture an image related to the business, and using the captured image, create a coded referral to Business 1 that can be shared on a social media site.

A second member, “User 2”, can then select the coded referral on the social media site. Once the referral is selected, the referral code is stored on the referral app initially in a list of as-yet unredeemed referrals. User 2 can redeem the referral by making a purchase at Business 1, by capturing a receipt (“redemption receipt”) and confirming the receipt at the referral platform. This closes the referral transaction between User 1 and User 2. In some embodiments, User 2 is barred from redeeming a referral at Business 1 after becoming a new customer of the business through the referral app. This measure protects against fraudulent usage of the referral system. However, User 2 can post a referral for business 1 on an electronic sharing platform as well.

Both the businesses and customers are incentivized to become members of the referral system. Businesses agree to pay a fee to the referral platform only when new customers purchase goods or services (a new customer is determined by the business. For example, a business may consider a new customer someone who hasn't used a referral code in over a month). The members involved in a referral transaction, including the original affiliate, the referrer (User 1), and the redeemer (User 2), are each given a portion of the fee, and are thus incentivized to participate. The referral system, including the referral app and referral platform, enables businesses to obtain new customers without the need to advertise, and to easily track all new customers and purchases made through the referral system.

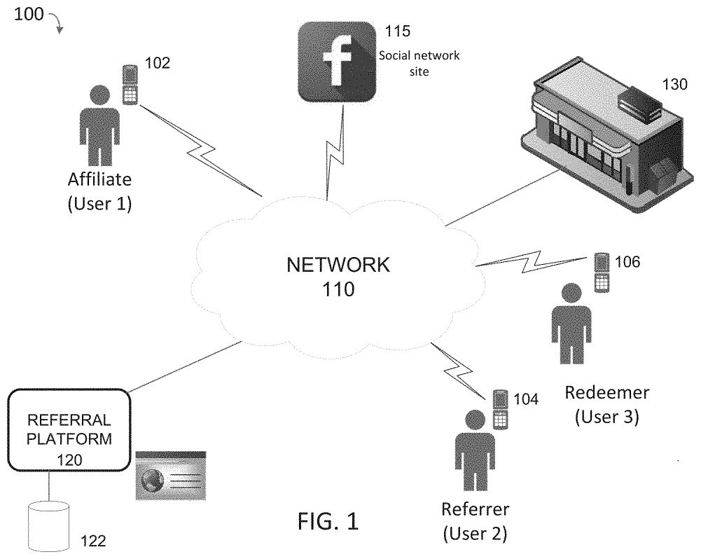

FIG. 1 is a schematic diagram illustrating a referral optimization and compensation system 100 according to an embodiment of the present invention. The system 100 includes a plurality of user devices, e.g., 102, 104, 106. While three user devices (shown with corresponding users, User 1, User 2, User 3) are shown, there is no limitation as to the number of user devices that can be included in the system. The user devices can be mobile devices such as smart phones, tablets, smart watches, laptops, PDAs and the like. The user devices 102, 104, 106 are coupled via a wireless link, such as a Wi-fi, or wireless telecom link, to a communication network 110. The users devices 102, 104, 106 include one or more processors operatively connected to various hardware and software components that serve to enable operation of the systems and methods described herein, as well as one or more of volatile and non-volatile memories, such as Random Access Memory (“RAM”), Read Only Memory (“ROM”) 114, Flash, Phase Change Memory or other memory types. Such memories can be fixed or removable, as is known to those of ordinary skill in the art. The user devices 102, 104, 106 also include I/O devices, such as a touch-sensitive display screen, camera, network interface, speaker, mouse, and keypad that allow the user devices to receive input data from and generate output data. Preferably, the user devices are equipped with a mobile operating system, such as iOS, Android, or Windows Mobile, or the like, enabling the devices to execute a variety of software applications, such as, for example, an internet browser, a media player, an email client, and the referral app disclosed further below.

User devices 102, 104 106 may use the network 110 to initiate communication with one or more social networks 115, including, for example, Facebook, LinkedIn, Twitter, Flickr, or Google+, to provide only a few possible examples. The term “social network” refers generally to a network of individuals, such as acquaintances, friends, family, colleagues, or co-workers, coupled via a communications network or via a variety of sub-networks. Potentially, users may form additional subsequent relationships because of social interaction via the communications network or sub-networks. Typically, users subscribe to or register with social networks in order to take advantage of the full functionality provided by the social network sites. For example, subscribers of social networks can be allocated resources, such as specific web pages, to post content, including text and images, that can be viewed by other users of the social network.

A referral platform 120 is also coupled to the communication network. Referral platform comprises a web-based platform, including a web site, that may be hosted on one or more servers. The referral platform 120 can be hosted at a specific site, or the platform can be hosted virtually on a cloud-based platform. The web-based platform provides user interfaces and applications to members for referral tracking, payments, billing, and other tasks as described below. In particular, the referral platform 120 presents a web interface that members of the referral system can access to perform various administrative tasks in relation to the referral system as will be described in greater detail below. The referral platform 120 either includes or is communicatively coupled to one or more databases 122 for storing data related to the members, businesses, purchases (e.g., receipt image data), codes, links, and the like. The data stored on databases 122 is preferably backed up and secured. In addition, one or more businesses 130 are communicatively coupled to the communication network 110 via one or more computing devices resident at or otherwise used by proprietors or employees of the business.

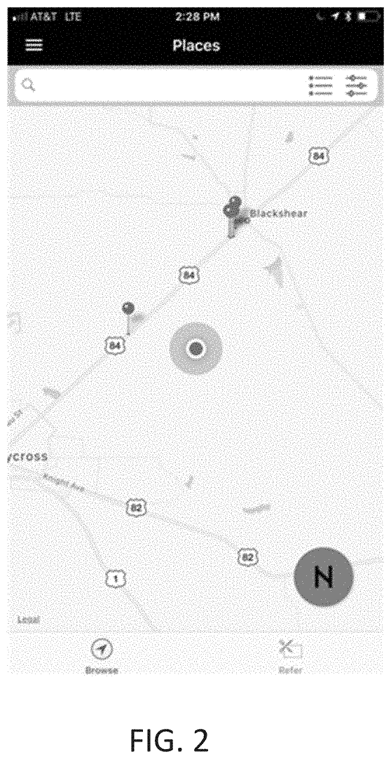

The referral app provides a convenient graphical user interface (GUI) including a number of options for navigating a referral system. For example, in some embodiments, the referral app includes a start screen, shown in FIG. 2, that displays a map that includes icons indicating businesses in the locale and specifies businesses that have registered with the referral system (shown by the “N” icon). Other aspects of the referral app user interface will be described in context of the business registration and referral processes in which they are used.

### Business Registration and Affiliation Process

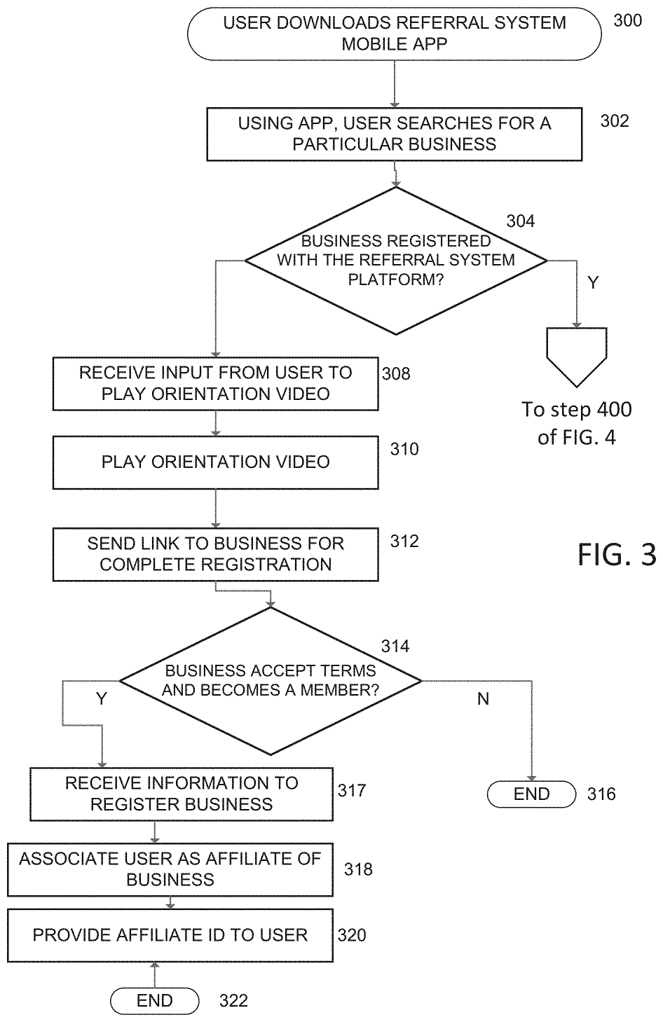

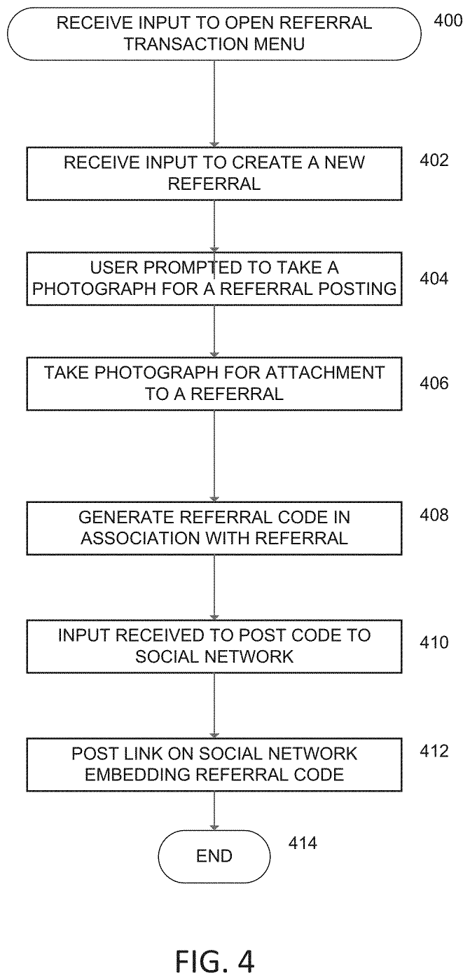

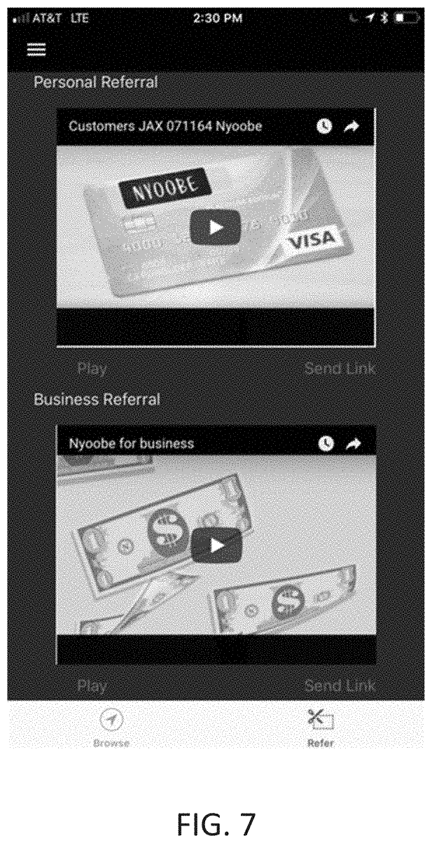

FIG. 3 is a flow chart of a process for registering a business and an affiliate with the referral system according to an embodiment of the present invention. In an initial step 300, a user (e.g., User 1) employs user device 102 to download the referral app from an application listing site, such as Google Play™. By downloading the referral app, and providing personal information, which is stored at the referral platform 120, User 1 becomes a member of the referral system. In a subsequent step 302, User 1 searches for a business 130 using the search function (shown in FIG. 2) of the referral app to determine whether business 130 is a member of the referral system. In step 304, it is determined, either automatically, or by User 1 perusing a list, whether business 130 is a member of the referral system. If business 130 has previously registered with and is a member of the referral system, User 1 can then initiate a referral transaction which is discussed below with reference to FIG. 4. If business 130 is not a member of the referral system, User 1 can approach the owners of business 130 to join the referral system. In one embodiment, in step 308, the referral app presents a screen, such as shown in FIG. 7, through which User 1 can activate a link to a video presentation through the referral app. The video describes the characteristics, terms, and advantages of the referral system to prospective business members. In step 310, user device 102 plays back the video which is shown to the prospective business owner. In the following step 312, a link to the referral system is sent to the business owner. Thereafter, in step 314, the business owner decides whether to become a member of the referral system. If, in step 314, the business owner decides not to join, the process ends in step 316. If, in step 314, the business owner decides to become a member of the referral system, in step 317, the business owner activates the link to the referral system and enters information into an interface such as a communication address (phone, email) of business 130 is entered into mobile device 102. During registration, business 130 obtains a business member ID. In step 318, the referral platform updates the records of the User 1 to store data indicating that User 1 is the affiliate of business 130. In a following step 320, User 1 is given an affiliate ID which is also stored in the referral platform. In step 322, the process ends.

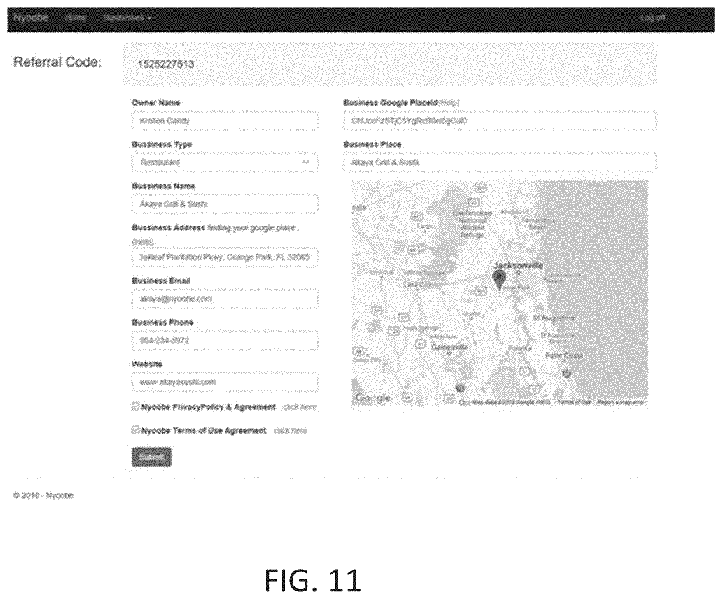

During registration, business 130 provides information to the referral platform including business name, business type (e.g., restaurant, retail), address and payment information. An example interface screen provided by the referral platform for entering such information is shown in FIG. 11. Business 130 is also required to agree to a set of terms and conditions regarding payments to the referral platform for referred business, the payment (discount) rates applicable, timing of payments and so forth. Once a business is registered, the referral platform provides an interface through which the business can track transactions made using the referral system.

### Referral Transaction Process

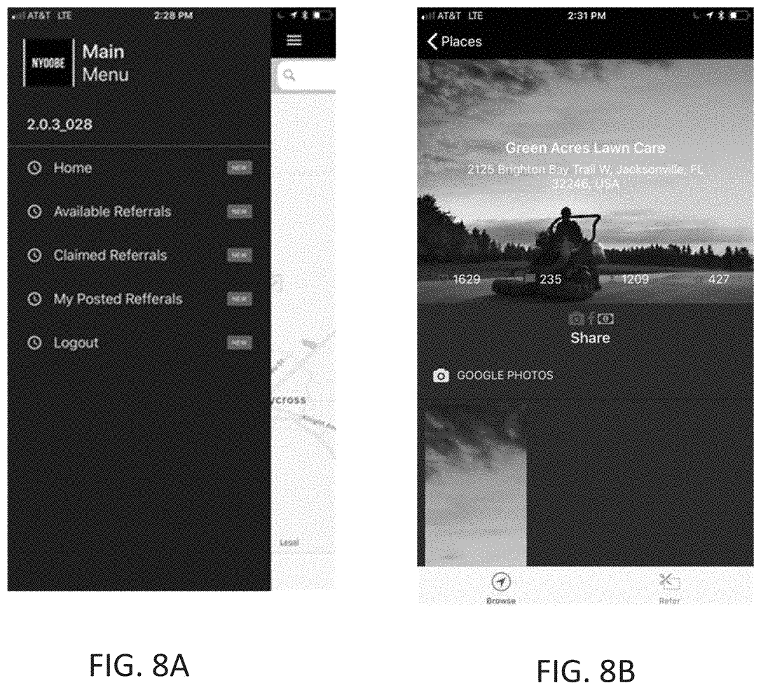

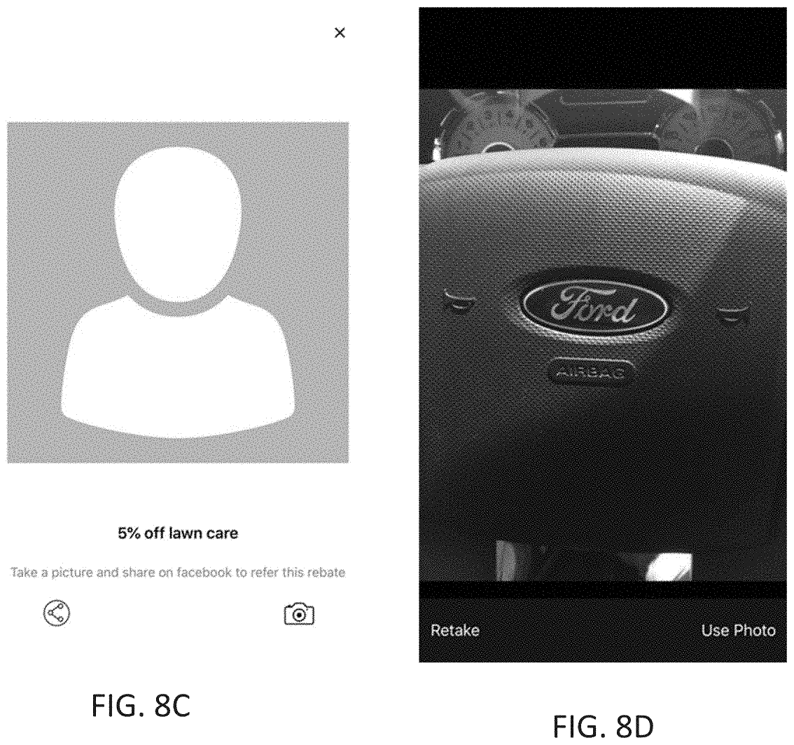

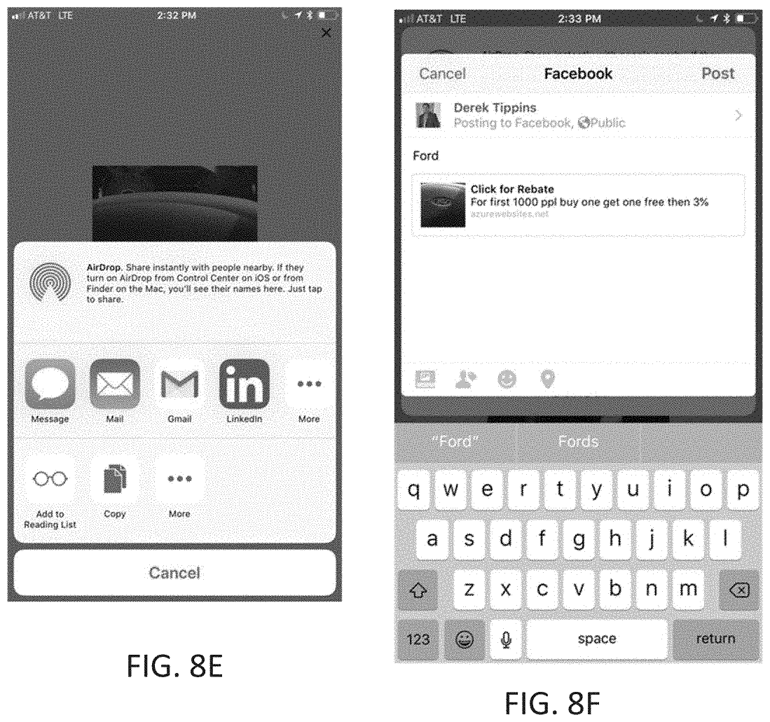

FIG. 4 is a flow chart of a first part of a referral transaction process according to an embodiment of the present invention which focuses on the interaction between the referring user (User 2) and the referral app. User 2 can be the same individual as User 1 if the user which registers a business also participates in a referral transaction. Once a business has registered and become a member of the referral system, new customers can be referred to the business. In an initial step 400, User 2 opens the referral app on user device 104 and activates a referral transaction menu. An example initial referral transaction menu is shown in FIG. 8A. The menu lists a number of options, and a “New” button included with each option. In step 402, in response to the user click on “New” on the item “My Posted Referrals” the referral app activates a referral initiation interface, such as shown in FIG. 8B. The referral initiation interface lists business information and offers the opportunity for the user to create a referral by activating the “Share” icon. Upon activation of the “Share icon”, in step 404, the user is prompted to take a photograph for referral posting. The photograph is preferably an image related to the business, such as a product, business premises or of the user referring the product or service. An example of a user interface screen for the photo prompt is shown in FIG. 8C. In step 406, a camera of user device is activated and integrated into the referral app as shown in FIG. 8D, and the user takes the photograph which is stored in path associated with the referral app. In some implementations, a message can be appended to the bottom of the image related to the referral, business, rebate, etc. The referral app may also include image editing functionality that allows users to modify the image.

In step 408, the referral app generates a unique referral code that is associated with both business 130 and User 2. For example, the referral code can be an alphanumeric code of some designated length (e.g., between 8 and 12 characters), and a set number of characters of the code can be specific to business 130 (e.g., the first 4-5 digits of the business member ID), and the remainder of the digits can be specific to User 2 (e.g., the first 4-5 digits of User 2's member ID). In step 410, User 2 activates an option to post the receipt and referral code to a social network 115. An example user interface screen presenting posting options to the user is presented in FIG. 8E. Example sites to which the referral can be posted can include a social network, Gmail, LinkedIn, and messaging application, among others. The referral app encodes a link to the photo with the referral code embedded to the social network (referred to after as the “referral link”) and posts the link on the social network in step 412. Depending on the share method, the user can also choose to type a personal message to add to the referral. FIG. 8F shows an example user interface screen in which a user can type under a posted referral. The first part of the referral transaction then ends in step 414.

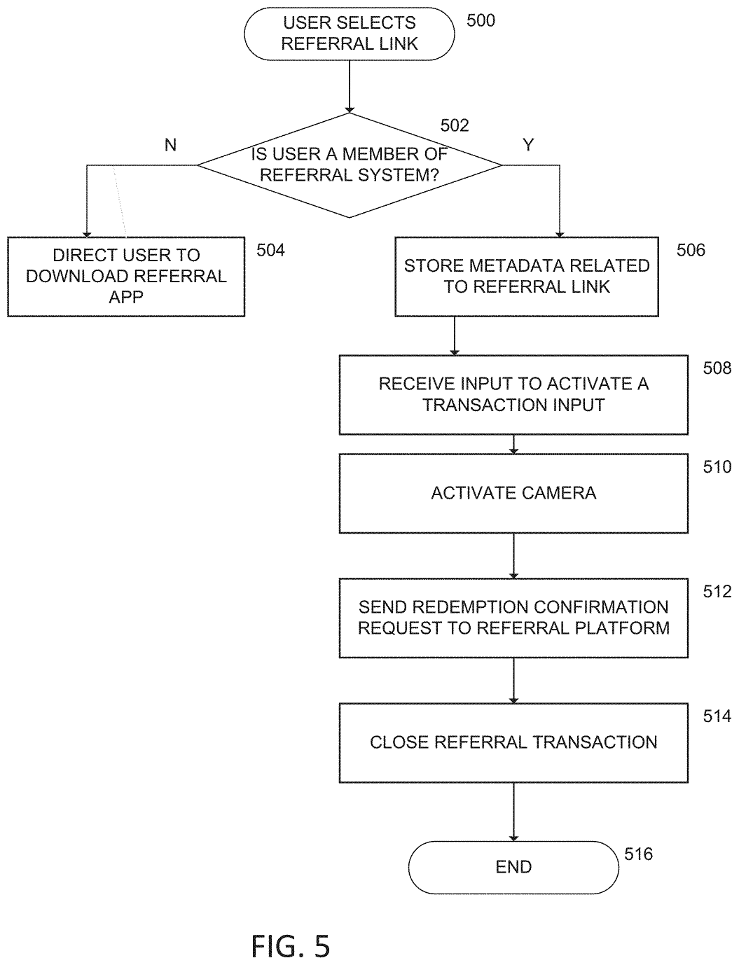

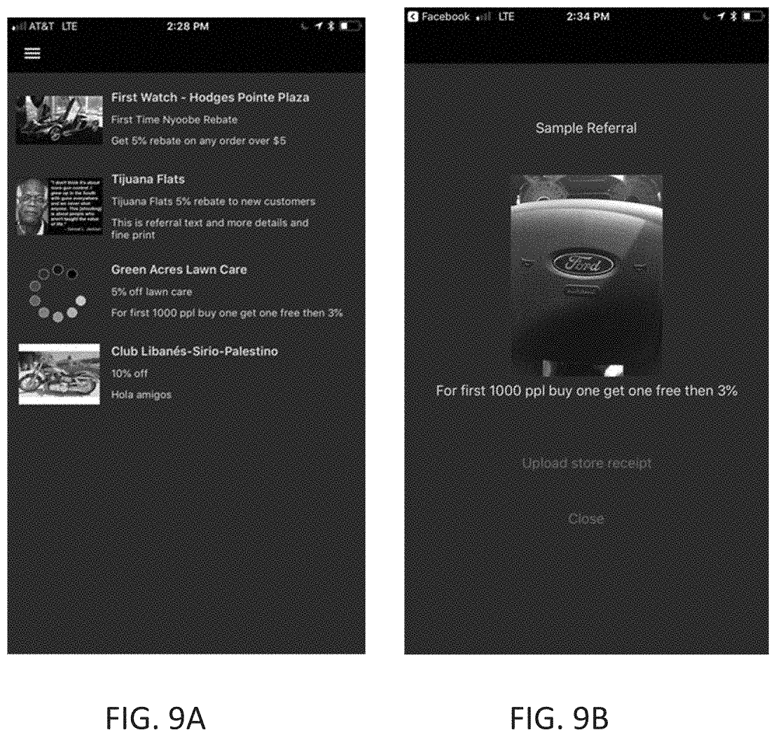

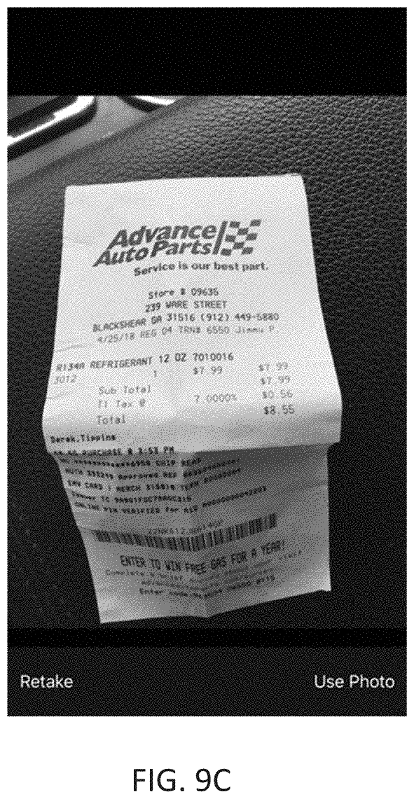

FIG. 5 is a flow chart of a second part of a referral transaction according to an embodiment of the present invention which focuses on the interaction between the redeeming user (User 3) and the referral app. In an initial step 500, User 3 selects the referral link posted on social network 115. In step 502, it is automatically determined whether User 3 is a current member of the referral system. Activation of the link causes a communication to be sent to the referral platform 120. A response from the referral platform indicates whether User 3 is a member of the referral system. If User 3 is a not member of the referral system, in step 504, user device is directed to an application listing site to download the referral app. Otherwise, if the user device 106 of User 3 already has the referral app, in step 506, the referral app stores metadata related to the referral link, including information concerning business 130 and the referral code in user device 106. In some implementations, the referral can initially be stored in a listing of referrals available through the referral system. An example user interface presenting a listing of available referrals is shown in FIG. 9A.

User 3 thereafter can make a purchase at business 130 on the list of referrals and then redeem the referral. In step 508, after User 3 has made a purchase from business 130 and obtained a new receipt, User 3 can elect to claim the referral by opening the referral app on user device 106 and activating a referral claim option. An example user interface showing a specific claimed referral with instructions to upload a receipt is shown in FIG. 9B. In step 510, the referral app activates the camera of user device 106, as shown in FIG. 9C, for taking a photograph of the new receipt, which is stored in path associated with the referral app. To redeem the referral, in step 512 the referral app sends a redemption confirmation request to the referral platform 120. Once confirmed, in step 514, the referral app closes the transaction by removing the referral link from the stored list and places a restriction, such as an IP block, that effectively prevents User 3 from redeeming a referral at business 130 again. This prevents the business from being subject to giving discounts to the same customers repeatedly, without reaching new customers. The method ends in step 516.

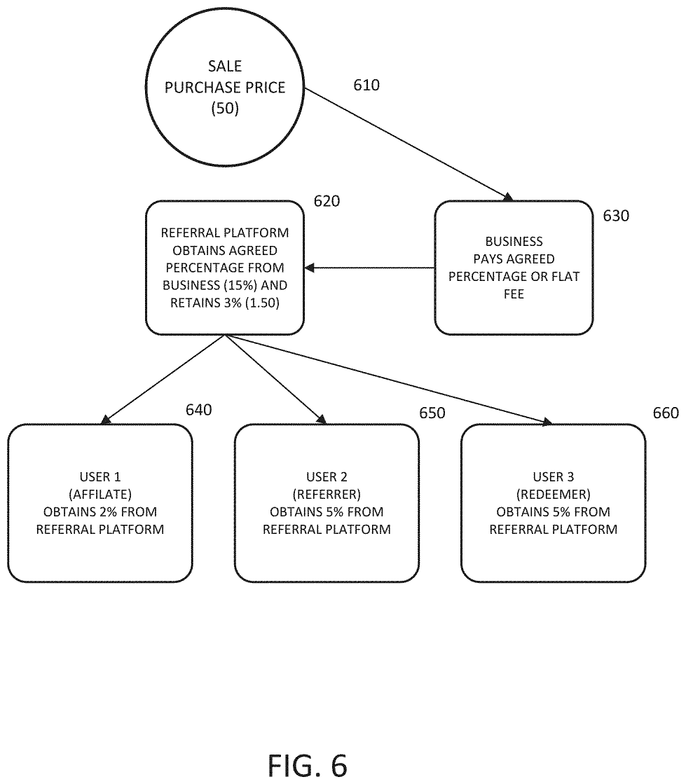

FIG. 6 is a block diagram depicting an example compensation arrangement of the referral system according to an embodiment of the present invention. In the example, a good or service is purchased for 50 dollars by the redeemer in a referral transaction (block 610). The terms of the referral agreement that the business originally signed can vary, but it the example depicted case, the business agrees to deduct 15 percent from the sale amount as a service fee to the referral platform (block 620). The referral platform retains a certain amount of the fee, in this example 3 percent, and distributes the rest of the fee to the affiliate of the business, the referrer and the redeemer of the transaction (block 630). In some instances, the business can set the referral percentage or a flat payment amount. In the example, the affiliate is paid two percent (block 640), and the referrer and redeemer are both paid 5 percent (blocks 650, 660). In this manner, the affiliate is paid a certain percentage for all transactions involving the business, while the referrer and redeemer are paid for only for the single transaction. The amount of the initial service fee can be set depending on the business type. For example, restaurants may be charged a different fee from a hardware store. The fee may also be set using a sliding scale, with larger sales volumes causing a drop in percentage fee rates.

There are several reasons why the referral system in accordance with embodiments of the present invention is advantageous to businesses. In addition to the ability to induce new customer visitations without advertising, the referral system can provide flexibility for business to opt out of the system under certain conditions. For example, in some embodiments, business can sign up with the referral system for a limited period of time, such as for a particular sales campaign. Upon expiration of the time period, the referral system automatically updates the information about the business, and the business is taken off of the current member list. A business may also list several offers concurrently.

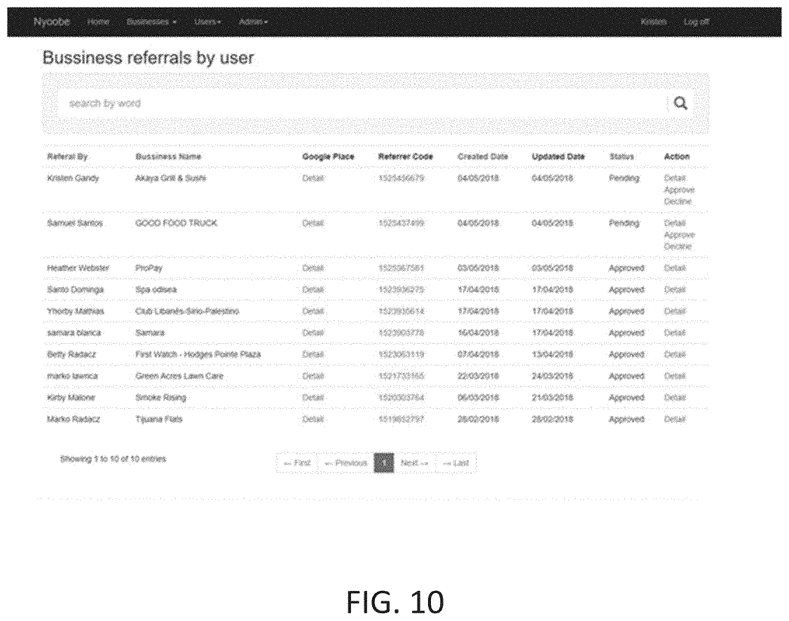

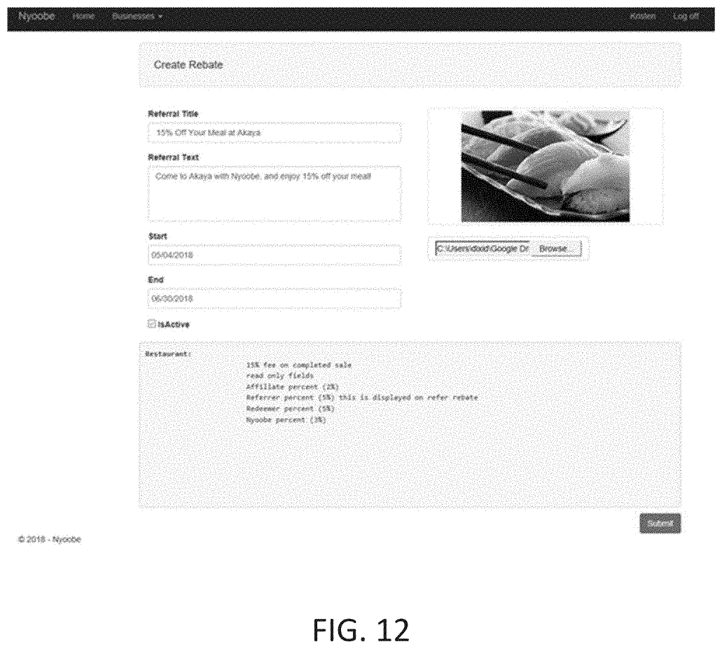

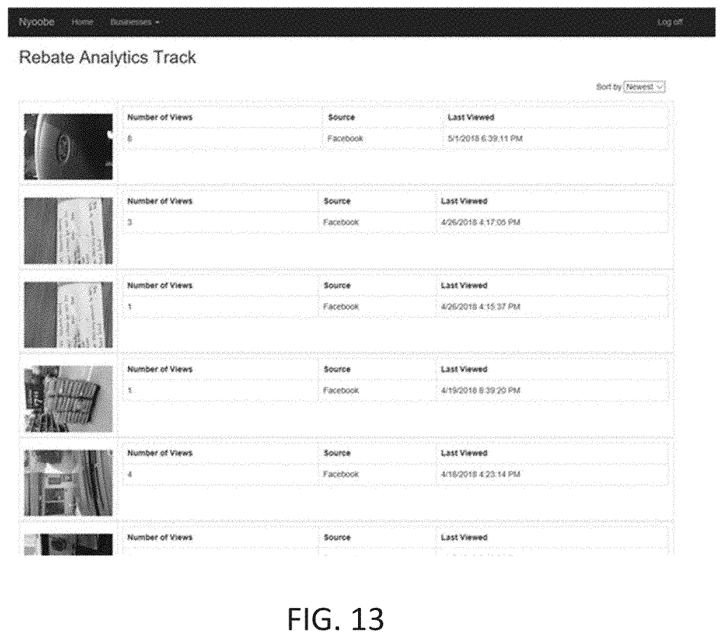

In addition, the referral platform enables the business to comprehensively track all sales that occur through referrals. In addition, all payments made to the referral platform are tracked as well. Through the referral platform, businesses can obtain current information as to how many new customers, and the volume of sales due to the new customers, and all other participants can readily determine how much they have earned through the referral system. FIG. 10 is an example interface provided by the referral system to member businesses. As shown, businesses can track referrals by user. In addition, business can create new referral offers directly through the referral platform. FIG. 12 is an example interface for entering a new referral offer. In some embodiments, the referral platform includes analytics and other tools to help business identify where business is generated. An example rebates analytics interface is shown in FIG. 13.

It is to be understood that any structural and functional details disclosed herein are not to be interpreted as limiting the systems and methods, but rather are provided as a representative embodiment and/or arrangement for teaching one skilled in the art one or more ways to implement the methods. It is to be further understood that like numerals in the drawings represent like elements through the several figures, and that not all components and/or steps described and illustrated with reference to the figures are required for all embodiments or arrangements.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing, and are not to be construed as limiting. However, it is recognized these terms could be used with reference to a viewer. Accordingly, no limitations are implied or to be inferred.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method of processing a referral transaction in a referral system having business and user members, the method comprising:
receiving, at a processor of a first user device, input from a first user for initiating a referral transaction;
capturing, using a camera coupled to the processor, an image relating to the referred business;
generating a unique referral code associated with member information of the user and the business;
communicating over a network to post a link that includes the referral code;
wherein activation of the link by a second user provides the second user a referral that can be redeemed at the member business; and
wherein the first user and the second user receive compensation from the referral system upon confirmation that the second user redeemed the referral.

2. The method of claim 1, further comprising:
receiving user input including information identifying a business;
sending a communication to a referral platform of the referral system including the information identifying the business; and
receiving back information as to whether the business is a member of the referral system from the referral system platform.

3. The method of claim 1, wherein the first user, second user and business each receive member identification numbers from the referral platform upon becoming members of the referral system.

4. The method of claim 3, wherein the referral code includes a portion of a member identification number of the first user and a portion of a member identification number of the business established.

5. A implemented method of processing a referral transaction in a referral system having business and user members, the method comprising:
receiving, at a processor of a user device, input from a user to activate a link to a referral associated with a business;
storing metadata related to the referral;
receiving input to activate a referral transaction based on the referral;
capturing, using a camera coupled to the processor, an image relating to the referral; and
communicating over a network with a referral platform to confirm redemption of the referral.

6. The method of claim 5, further comprising blocking the user device from obtaining additional referrals associated with the business.

7. The method of claim 5, further comprising, upon receiving input to a user to activate the link, determining whether the user device includes an application adapted for processing transactions in the referral system.

8. The method of claim 7, further comprising initiating an automatic download of the application adapted for processing transactions in the referral system if it is determined that the user device does not include the application.

9. The method of claim 1, further comprising:
determining if a business is a member of the referral system;
presenting a video to an owner of the business if it is determined that the business is not a member of the referral system; and
sending a link to the business to register as a member of the referral system;
wherein the first user is affiliated with the business upon registration of the business with the referral system, and the first user receives compensation for all referral transactions conducted by the business.

10. The method of claim 9 comprising compensating the first user as an affiliate for inducing the business to register with the referral system.
